(19) United States
(12) Patent Application Publication
(10) Pub. No.: US 2007/0042855 A1
(43) Pub. Date: Feb. 22, 2007

(54) External gear of planetary reduction gear having cycloid tooth and method of machining the same

(75) Inventor: Huyn Gook Lee, Bucheon City (KR)

Correspondence Address: BIRCH STEWART KOLASCH & BIRCH, PO BOX 747, FALLS CHURCH, VA, 22040-0747, US

(73) Assignee: HAISUNG INDUSTRIAL SYSTEMS CO., LTD.

(21) Appl. No.: 11/250,394

(22) Filed: Oct. 17, 2005

(30) Foreign Application Priority Data
Aug. 19, 2005 (KR) 10-2005-0076232

(51) Int. Cl. F16H 23/00

(52) U.S. Cl. 475/164

(57) ABSTRACT

Provided is an external gear of a planetary reduction gear having a cycloid tooth, a tooth part of the external gear having a cycloid tooth has a tooth apex protruded from a distal end, a tooth valley having a groove, and contact parts curvedly sloped between the tooth apex and the tooth valley, an outer surface of the external gear is divided into an abraded part corresponding to the tooth apex and the contact parts, and an un-abraded part corresponding to the tooth valley. The external gear of a reduction gear having a cycloid tooth of the present invention is capable of improving machining productivity to obtain economic effect and maintaining performance of the planetary reduction gear by abrading only a portion of an outer surface of the external gear, at which friction and contact pressure are concentratedly applied, and forming a groove at a tooth valley, at which the contact pressure is not applied, by undercut, without abrading an entire surface of the external gear, in order to increase anti-friction and durability and improve supporting force and precision of a tooth part with which the eternal gear and an internal gear of the planetary reduction gear having a cycloid tooth are meshed.

### CROSS-REFERENCE TO RELATED APPLICATION

This application claims the benefit of Korean Patent Application No. 10-2005-0076232, filed Aug. 19, 2005, the disclosure of which is hereby incorporated herein by reference in its entirety.

### BACKGROUND OF THE INVENTION

1. Field of the Invention

The present invention relates to an external gear of a reduction gear having a cycloid tooth and, more particularly, to an external gear of a reduction gear having a cycloid tooth capable of maintaining basic performance, improving machining productivity, and simplifying manufacturing processes to improve machinability by dividing the external gear of the reduction gear having an eccentrically rotated cycloid tooth into an abraded part machined by an abrasion device and an un-abraded part having a groove by undercut without abrasion. Especially, it is possible to prevent efficiency from lowering due to load or friction loss on a portion with which an external gear and an internal gear are meshed, maximally suppress torque variations and vibrations by machining errors by forming the groove by undercut without machining a portion of the gear, and facilitate machining of the gear manufacture.

2. Description of the Related Art

Generally, a reduction gear is a device for reducing a high speed of rotational force input from a power transmission by a predetermined ratio to output a low speed of rotational force, which may be classified various types according to its use; typically, a planetary reduction gear has been widely used.

Especially, the planetary reduction gear is also called as a cycloid reduction gear, which has been widely used in various fields due to characteristics such as large torque transmission and reduction ratio.

As shown in FIGS. 1A and 1B, a conventional planetary reduction gear is eccentrically rotated as an external gear 100 is meshed with an internal gear 220. A tooth part 120 of the eccentrically rotated external gear 100 has a cycloid gear shape, and the internal gear 220 has internal gear pins 222 radially meshed therewith spaced apart from each other to be engaged with the tooth part 120 of the external gear 100.

At this time, the tooth part 120 of the external gear 100 is abraded and polished in order to improve anti-friction, durability, and precision.

However, as shown in FIG. 2A, in manufacturing/machining the external gear of the conventional planetary reduction gear, when a gear disk is machined, a tooth apex 120a and a tooth valley 120b of the tooth part 120 of the external gear 100 are primarily machined to have a size larger than a standard size, and then, the tooth apex 120a and the tooth valley 120b are abraded to obtain a high quality surface using an abrasion tool 300 shown in FIG. 2B, thereby consuming a lot of operation time. In addition, in order to maintain an optimal state of the tool, tool dressing is excessively repeated to wear the abrasion tool 300 and decrease productivity. That is, in a process of abrading a cycloid disk tooth cut by a primary hobbing machine, the conventional method should fix the gear disk to a jig of the abrasion device to abrade an entire surface including the tooth valley to obtain the high quality surface, thereby consuming a lot of operation time and decreasing productivity to increase manufacturing cost and decrease competition force.

### SUMMARY OF THE INVENTION

The present invention, therefore, solves aforementioned problems associated with conventional devices by providing an external gear of a reduction gear having a novel shape of cycloid tooth capable of simplifying operation processes according to manufacturing/machining of the external gear of the planetary reduction gear having a cycloid tooth and improving machining productivity by abrading only a tooth apex and contact parts of an outer surface of the external gear, at which friction and contact pressure are concentratedly applied, and forming a groove at a tooth valley, at which the contact pressure is not applied, by undercut, without abrading an entire surface of the external gear, in order to increase anti-friction and durability and improve supporting force and precision of a tooth part with which the eternal gear and an internal gear of the planetary reduction gear having a cycloid tooth are meshed.

It is another aspect of the present invention to provide a method of machining an external gear of a reduction gear having a novel shape of cycloid tooth capable of reducing abrasion time to improve productivity by machining the cycloid tooth and to automate manufacturing equipment to reduce manufacturing cost and obtain competition force of products using a process of primarily machining a gear disk having the cycloid tooth at its periphery, a process of undercutting a tooth valley of the external gear to a predetermined depth, and a process of abrading a tooth apex and contact parts of the tooth part of the external gear using an abrasion device.

In an exemplary embodiment of the present invention, a method of machining an external gear of a reduction gear having a cycloid tooth includes: primarily machining a disk to make a gear having a cycloid tooth at its periphery; undercutting an un-abraded part, at which a contact pressure of the primarily machined gear is not applied, to form a groove; and abrading a tooth apex and both contact parts except the groove using an abrasion tool.

In another exemplary embodiment according to the present invention, an external gear of a reduction gear having a cycloid tooth includes: a tooth part 12 having a cycloid tooth curve, a tooth apex 12a protruded at a distal end of each tooth, a tooth valley 12b recessed at a proximal end of each tooth, a groove 13 formed by undercut, and contact parts 12c curvedly sloped between the tooth apex 12a and the tooth valley 12b.

### BRIEF DESCRIPTION OF THE DRAWINGS

The above and other features of the present invention will be described in reference to certain exemplary embodiments thereof with reference to the attached drawings in which:

FIG. 1A is a cross-sectional view of a conventional planetary reduction gear;

FIG. 1B is a side view of a conventional planetary reduction gear;

FIG. 2A is an example a conventionally machined cycloid gear;

FIG. 2B is an example of an abrasion tool for machining a conventional cycloid gear;

FIG. 3A is a view illustrating a machining process of a cycloid gear in accordance with the present invention;

FIG. 3B is an example of a cycloid gear machined using an abrasion tool in accordance with the present invention;

FIG. 4 is an enlarged view of a planetary reduction gear using a cycloid gear in accordance with the present invention;

FIG. 5 is an enlarged view of a portion of an undercut part of a tooth valley of a cycloid gear in accordance with the present invention;

FIG. 6A is an overall conceptual view of a frictionally engaged state of a rotated cycloid gear and inner pins in accordance with the present invention;

FIG. 6B is a schematic view representing a pressure direction by a frictional engagement of a rotated cycloid gear and inner pins in accordance with the present invention;

FIG. 7A a partially enlarged view representing a contact pressure point generated by friction of a cycloid gear and inner pins in accordance with the present invention;

FIG. 7B is a partial view representing contact parts generated by rolling of a cycloid gear and inner pins in accordance with the present invention;

FIG. 7C is a partially enlarged view representing a contact relationship of a tooth valley and a groove when a cycloid gear and inner pins in accordance with the present invention;

FIG. 8 is an overall structure representing a contact pressure direction and a contact angle of a rotated cycloid gear and inner pins in accordance with the present invention;

FIG. 9A an example illustrating a minimum contact angle of a rotated cycloid gear in accordance with the present invention; and

FIG. 9B is a graph representing a contact force applied to an initial pin to a final pin in contact with a rotated cycloid gear in accordance with the present invention.

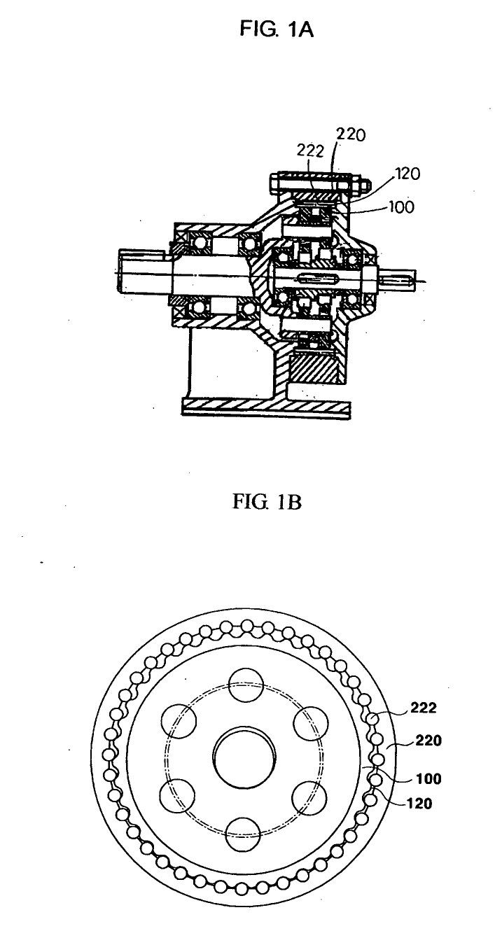

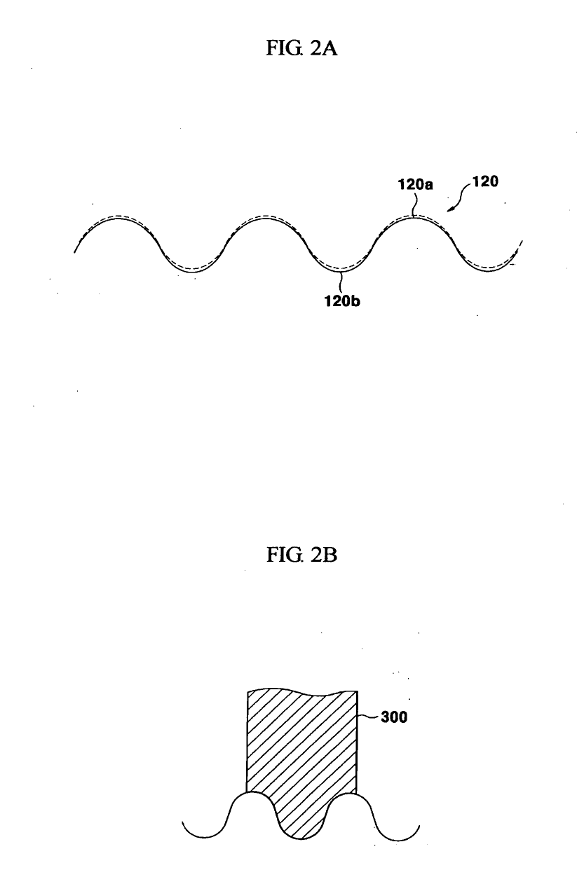

### DETAILED DESCRIPTION OF THE INVENTION

Hereinafter, a method of machining a planetary reduction gear having a cycloid tooth in accordance with the present invention will be described.

A First Process: Machining a Gear Disk (an Uncut Disk)

A gear disk is primarily machined to form a basic product having a cycloid gear using a cutting machine. At this time, the primarily machined cycloid gear is cut to form a tooth apex 12a having a size larger than a desired size by about 0.5˜1 mm. This is in order to remain a thickness, which is to be abraded by the following abrasion process. However, a tooth valley 12b is cut to have a size equal to a desired depth.

That is, the tooth apex 12a and the tooth valley 12b formed at a periphery of the basic product have an abraded part to which a pressure is applied when the gear is rotated by a biased force generated from inner pins 22 in contact with an internal gear 20, and an un-abraded part to which no pressure is applied though the gear is rotated to be in contact with the inner pins. That is, the abraded part is corresponding to the tooth apex and the contact parts, and the un-abraded part is corresponding to the tooth valley.

Therefore, the present invention is capable of simplifying operation processes by abrading the basic product using the abrasion device in a divided manner.

A Second Process: Undercutting the Tooth Valley

After primarily machining the uncut disk to manufacture the cycloid gear during the first process, the tooth valley 12b is undercut to form a groove 13.

At this time, the tooth valley is undercut to a predetermined depth in a centerline direction to form the groove 13.

As a result of the formation of the groove 13 by undercut, since the inner pins 22 is not in contact with the tooth valley 12b though the tooth part 12 is rotated by the load, there is no necessity of additionally abrading the tooth valley 12b to thereby reduce abrading time and increase machining efficiency.

A Third Process: an Abrasion Process

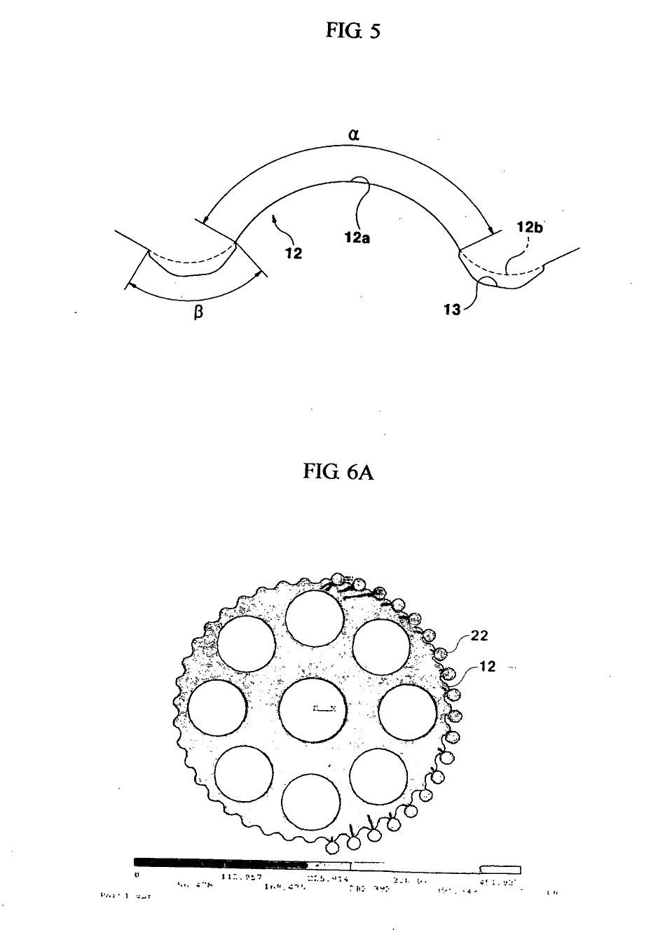

After forming the groove 13 by undercut of the tooth valley 12b during the second process, the tooth apex 12a and the both contact parts 12c of the tooth apex 12a are abraded using an abrasion tool 30 having a shape conforming to a profile of the tooth apex 12a and the both contact parts 12c so that the tooth apex 12a and the both contact parts 12c corresponding to an α portion only shown in FIG. 5 are abraded.

At this time, since the tooth valley 12b has the undercut groove, there is no necessity of abrasion.

As described above, the uncut disk as a raw product of the planetary reduction gear having a cycloid tooth is formed to have an entirely waveform of cycloid tooth along a periphery of the external gear 10.

In addition, since the tooth apex 12a protruded from a distal end of the tooth part 12 and the contact parts 12c curvedly sloped between the tooth apex 12a and the tooth valley 12b are abraded, it is possible to provide smooth friction performance when the inner pins 22 are in contact with the tooth part 12, increase anti-friction and durability, and improve rigidity, supporting force, and precision.

As described above, the disk is primarily machined to have a cycloid tooth at its periphery, then, the tooth valley 12b is abraded to have the groove 13 having a predetermined depth, and then, their surfaces are abraded using the abrasion tool 30 having a shape conforming to a profile of the tooth apex 12a and the both contact parts 12c, whereby it is possible to simplify and facilitate the machining process of the cycloid tooth to reduce operation time of the abrasion device to thereby increase productivity.

Hereinafter, the present invention will be described in conjunction with the accompanying drawings.

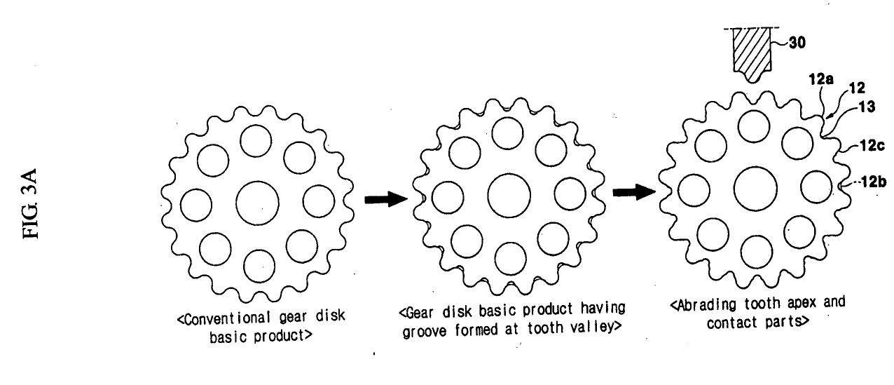

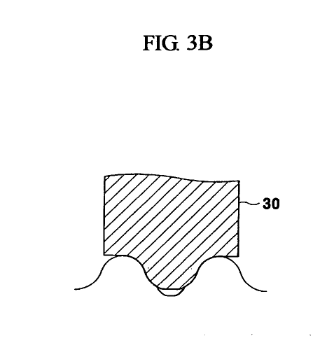

FIG. 3A is a view illustrating a machining process of a cycloid gear in accordance with the present invention, which also represents a simple machining process of the present invention. First, an uncut disk is primarily machined to form a basic product. At this time, according to a machining method, the basic product may have a saw tooth shape or a waveform at its periphery.

In the present invention, while the shape of the tooth machined at the periphery of the basic product is not important, the tooth should be readily and effectively abraded during machining of the tooth shape into the cycloid gear.

After providing the basic product through the first process, the tooth valley 12b is undercut to form a groove 13 by the second process. The undercut of the tooth valley 12b is performed at a time using a cutting machine such that the cutting time is remarkably shorter than the abrading time.

When the tooth valley 12b is undercut during the second process, the abrasion tool 30 abrades the tooth apex 12a and the contact parts 12c of the tooth part 12 to simply complete the machining process.

FIG. 3B is an example of a cycloid gear machined using an abrasion tool in accordance with the present invention, it being appreciated that the gear has a small friction coefficient since the tooth valley is not machined due to the undercut of the tooth.

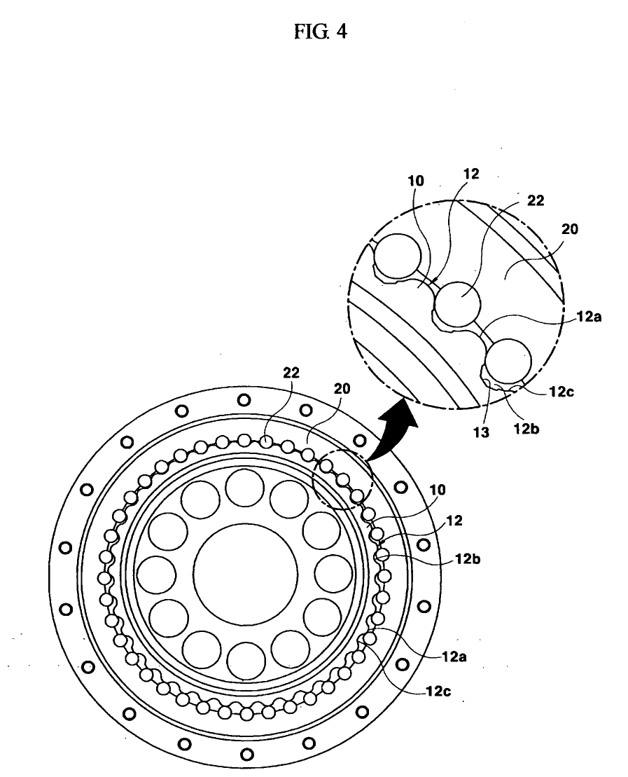

FIG. 4 is an enlarged view of a planetary reduction gear using a cycloid gear in accordance with the present invention, representing an overall structure of a side surface of the planetary reduction gear. The external gear 10 of the planetary reduction gear having a cycloid tooth in accordance with the present invention includes the tooth part 12 having the tooth apex 12a protruded from a distal end of the tooth part 12, the tooth valley 12b having a recessed shape, and the contact parts 12c curvedly sloped between the tooth apex 12a and the tooth valley 12b. The tooth apex 12a and the contact parts 12c are corresponding to the abraded part α, the tooth valley 12b is corresponding to the un-abraded part β, and the groove 13 is undercut at the tooth valley 12b to prevent the inner pins 22 of the internal gear 20 from being in contact with the tooth valley 12b of the external gear 10.

As described above, the external gear 10 is meshed with the internal gear 20 to be eccentrically rotated, the tooth part 12 has a wave form of cycloid gear, a plurality of inner pins 22 spaced apart from each other are engaged with the internal gear 20, and the inner pins are meshed with the teeth 12 of the external gear 10.

FIG. 5 is an enlarged view of a portion of an undercut part of a tooth valley of a cycloid gear in accordance with the present invention, in abrading the tooth part 12 of the external gear 10 of the planetary reduction gear having a cycloid tooth in accordance with the present invention, the tooth apex 12a and the contact parts 12c are designated as the abraded part α, which is abraded by the abrasion tool 30 in order to increase anti-wearing, strength, and precision, and the tooth valley 12b is designated as the un-abraded part β, which is undercut to form the groove 13 in order to minimize unnecessary friction due to contact of the inner pins with the tooth valley 12c.

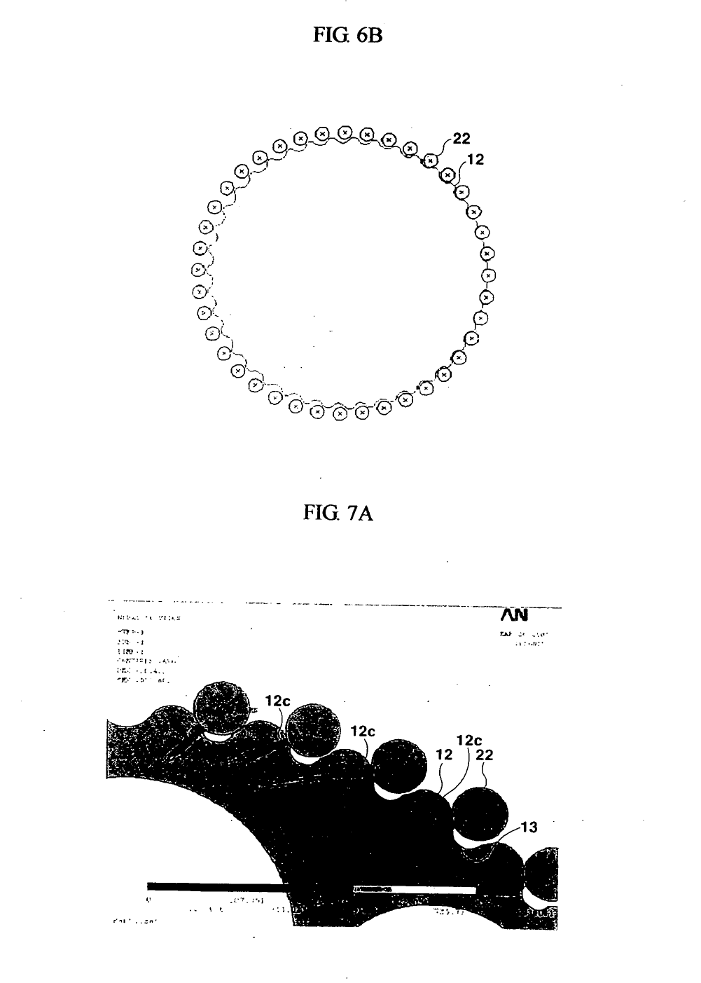

FIG. 6A is an overall conceptual view of a frictionally engaged state of a rotated cycloid gear and inner pins in accordance with the present invention, and FIG. 6B is a schematic view representing a pressure direction by a frictional engagement of a rotated cycloid gear and inner pins in accordance with the present invention. The external gear 10 and the internal gear 20 of the planetary reduction gear having a cycloid tooth are meshed with each other, and the external gear 10 is eccentrically rotated.

At this time, since the external gear 10 is eccentrically rotated, the tooth valley 12c, the contact parts 12b and the tooth apex 12a of the tooth part 12, and the inner pins 22 of the internal gear 20 are sequentially meshed with one another.

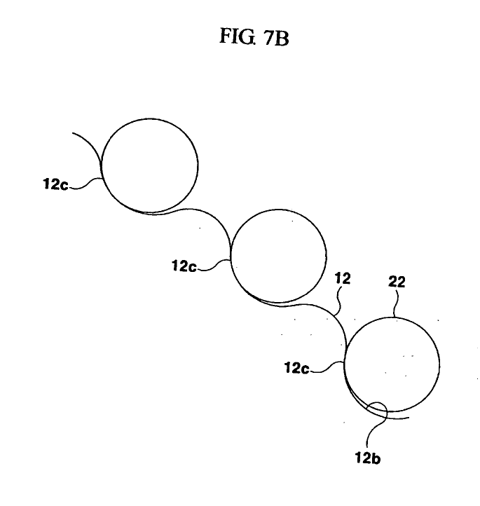

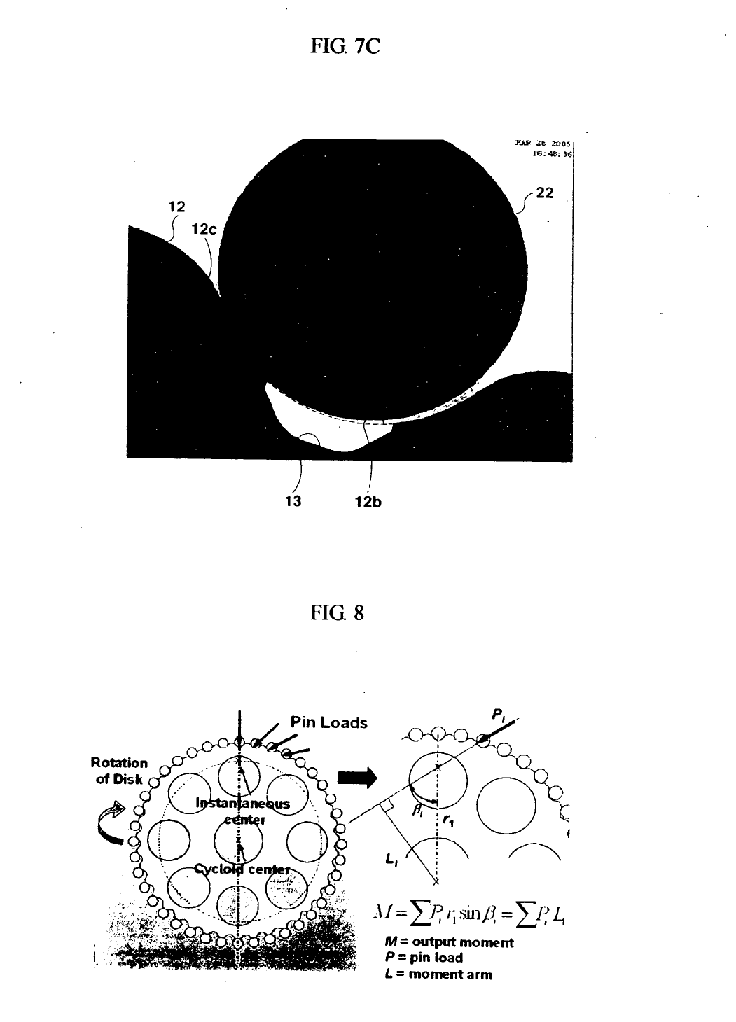

FIG. 7A a partially enlarged view representing a contact pressure point generated by friction of a cycloid gear and inner pins in accordance with the present invention, FIG. 7B is a partial view representing contact parts generated by rolling of a cycloid gear and inner pins in accordance with the present invention, and FIG. 7C is a partially enlarged view representing a contact relationship of a tooth valley and a groove when a cycloid gear and inner pins in accordance with the present invention.

The cycloid gear in accordance with the present invention is adapted to a hollow or solid planetary reduction gear to reduce a high speed of input into a low speed of output. That is, the external gear 10 is meshed with the internal gear 20 having a diameter larger than that of the external gear 10 to transmit the reduced speed of rotational force through an output shaft.

In this process, the external gear 10 and the internal gear 20 are meshed with each other, and the external gear 10 is eccentrically rotated. Therefore, though a pressure is generated to be applied to a contact direction of the tooth apex 12a and the contact parts 12c of the tooth part 12, the pressure direction is varied according to a position of the sequential contact of the external gear 10 with the inner pins 22 of the internal gear 20, as shown in FIGS. 7A and 7B.

That is, the contact position of the inner pins 22 in contact with the tooth part 12 is a state that one of the inner pins 22 is initially seated on the tooth valley 12b, at this time, both sides of the inner pin and the contact parts 12c at both sides of the tooth valley 12b are in contact with each other, but there is no contact pressure. Therefore, when the gear is rotated, an initial pressure is generated in a direction biased by a rotational force by the contact of one surface of the inner pin and one of the contact parts 12c between the tooth apex 12a and the tooth valley 12b.

Accordingly, when the gear is continuously rotated, the inner pins of the internal gear meshed with the tooth part 12 are rotated in a biasing direction as positions of the inner pins are sequentially varied in a rotational direction.

At this time, when the inner pin in contact with the tooth part 12 is located at a center of the tooth valley 12b according to the rotation of the gear disk, the inner pin is in contact with the contact parts 12c at both sides of the tooth valley 12b, but there is no pressure to both sides. Especially, since a center axis of the tooth valley 12b is aligned to a center of the gear disk, and a rotational direction is perpendicular to a centerline of the tooth valley, the tooth valley and the inner pin is in contact with each other without any pressure. Therefore, though the center of the tooth valley 12b is undercut to form the groove 13 as shown in FIG. 7C, the groove 13 has no affection to the contact pressure.

In other words, it is not necessary to abrade the tooth valley 12b since there is no pressure applied to the tooth valley 12b, the groove 13 prevents the inner pin from being in contact with the tooth valley 12b to increase a life span of the reduction gear. In addition, the groove 13 functions as a reservoir containing a small amount of lubrication oil to cool heat generated due to friction between the tooth part of the external gear and the inner pin of the internal gear to make the gear smoothly rotate to prevent noise from generating.

FIG. 8 is an overall structure representing a contact pressure direction and a contact angle of a rotated cycloid gear and inner pins in accordance with the present invention, the undercut groove 13 of the tooth valley 12b being omitted for the sake of convenience.

An output moment and a pin load generated when the cycloid gear is in contact with the inner pins can be expressed as the following formulae.

$$M = \sum {P}_{i} {r}_{1} sin {β}_{i} = \sum {P}_{i} {L}_{i} \\ M = output moment \\ P = pin load \\ L = moment arm \qquad [ Formulae ]$$

where the Pin load expression is,

$${P}_{i} = \frac{{ML}_{i}}{{\sum }_{1}^{{Z}_{p} / 2} {L}_{i}^{2}}$$

$${P}_{i} = {P}_{m} ( \frac{{L}_{i}}{{r}_{1}} )$$

$${P}_{ix} = {P}_{i} sin {β}_{i} = \frac{{P}_{m}}{{r}_{1}} {L}_{1} sin {β}_{i}$$

$${P}_{iy} = {P}_{i} cos {β}_{i} = \frac{{P}_{m}}{{r}_{1}} {L}_{1} cos {β}_{i}$$

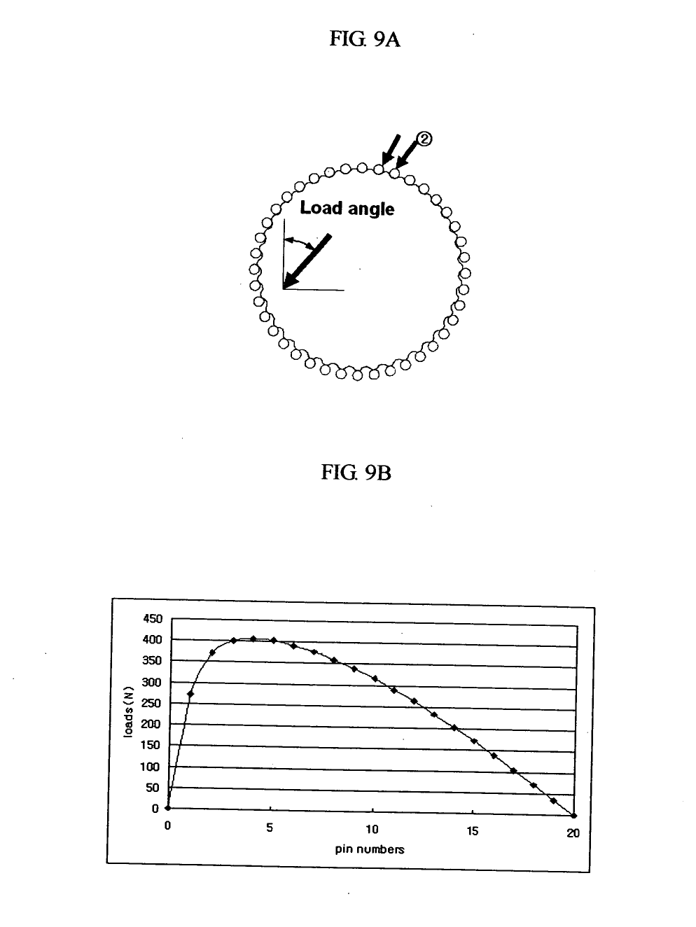

FIG. 9A an example illustrating a minimum contact angle of a rotated cycloid gear in accordance with the present invention, and FIG. 9B is a graph representing a contact force applied to an initial pin to a final pin in contact with a rotated cycloid gear in accordance with the present invention.

That is, in the planetary reduction gear of the present invention, the external gear 10 is mashed with the internal gear 20 to be eccentrically rotated, the tooth part 12 has a cycloid gear shape, the internal gear 20 has a plurality of inner pins 22 spaced apart from each other, and the inner pins 22 are meshed with the tooth part 12 of the external gear 10.

Therefore, as shown in FIG. 9A, when the plurality of inner pins are meshed with the tooth parts formed at a periphery of the disk, and the external gear is eccentrically rotated, one of the inner pins have a contact pressure. The contact pressure can be represented as FIG. 9A according to claim each pin load angle on a perpendicular line of a contact point about a contact surface.

As can be seen form FIGS. 9A and 9B, in the cycloid gear of the planetary reduction gear, when an initially rotated pin is referred as a number 1 pin, a number 2 to a number 7 of pins have the largest contact pressure. In addition, as shown in FIGS. 4 to 8, the tooth valley of the tooth part has no contact pressure, as a result, though the groove is formed in the tooth valley to configure the cycloid gear in accordance with the present invention, the cycloid gear has performance equal to the conventional reduction gear, and further, it is possible to increase anti-wearing characteristics, strength and precision. In addition, since the groove 13 is formed at the tooth part 10 of the external gear 10 by the undercut, it is possible to facilitate manufacture and machining to improve productivity, without an abrasion process of the tooth valley.

As described above, an external gear of a reduction gear having a cycloid tooth of the present invention is capable of improving machining productivity to obtain economic effect and maintaining performance of the planetary reduction gear by abrading only a portion of an outer surface of the external gear, at which friction and contact pressure are concentratedly applied, and forming a groove at a tooth valley, at which the contact pressure is not applied, by undercut, without abrading an entire surface of the external gear, in order to increase anti-friction and durability and improve supporting force and precision of a tooth part with which the eternal gear and an internal gear of the planetary reduction gear having a cycloid tooth are meshed.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. In an external gear of a planetary reduction gear having a cycloid tooth, the external gear (10) being meshed with an internal gear (20) and eccentrically rotated, the external gear (10) having a tooth part (12) formed of a curved cycloid tooth, the internal gear (20) including a plurality of inner pins spaced apart from each other and mashed with the tooth part (12) of the external gear,
characterized in that the tooth part (12) of the external gear (10) having a cycloid tooth has a tooth apex (12a) protruded from a distal end, a tooth valley (12b) having a groove (13), and contact parts (12c) curvedly sloped between the tooth apex (12a) and the tooth valley (12b),
an outer surface of the external gear is divided into an abraded part α corresponding to the tooth apex (12a) and the contact parts (12c), and an un-abraded part β corresponding to the tooth valley (12b).

2. The external gear of the planetary reduction gear according to claim 1, the tooth valley (12b) of the tooth part (12) is the un-abraded part β, and has the groove (13) by a predetermined undercut to prevent an inner pin from being in contact with the tooth valley.

3. A method of machining an external gear of a planetary reduction gear having a cycloid tooth comprising:
primarily machining a disk to make a gear having a cycloid tooth at its periphery;
undercutting an un-abraded part β at which a contact pressure of the primarily machined gear is not applied, to form a groove; and
abrading an abraded part α of the tooth apex and both contact parts except the groove using an abrasion tool.
